(19) United States
(12) Patent Application Publication
(10) Pub. No.: US 2020/0263343 A1
(43) Pub. Date: Aug. 20, 2020

(54) WATER-FREE WASHING MACHINE BETWEEN INNER AND OUTER BARRELS

(71) Applicant: QINGDAO HAIER WASHING MACHINE CO., LTD., Shandong (CN)

(72) Inventors: Zunan LIU, Shandong (CN); Limei YANG, Shandong (CN); Dafeng FANG, Shandong (CN); Xiushun SONG, Shandong (CN); Kai XU, Shandong (CN); Yiyang LIU, Shandong (CN)

(73) Assignee: QINGDAO HAIER WASHING MACHINE CO., LTD., Shandong (CN)

(21) Appl. No.: 16/330,635

(22) PCT Filed: Sep. 6, 2017
(86) PCT No.: PCT/CN2017/100673

§ 371 Date: Mar. 16, 2020

(30) Foreign Application Priority Data
Sep. 6, 2016 (CN) 201610805506.9

(51) Int. Cl. D06F 39/08; D06F 37/30; D06F 23/04; D06F 34/10; H02J 7/02; H02J 50/10

(52) U.S. Cl. CPC D06F 39/083; D06F 37/304; H02J 50/10; D06F 34/10; H02J 7/02; D06F 23/04

(57) ABSTRACT

A washing machine includes an outer barrel and an inner barrel rotatably arranged in the outer barrel. During the washing/rinsing process, the inner barrel contains water, and there is no water between the inner barrel and the outer barrel. A drainage hole is arranged on the bottom of the inner barrel. A drain-sealing device and a driving device are arranged on a bottom of the inner barrel. The drain-sealing device comprises a sealing part cooperating with the drainage hole to control the opening/closing of the drainage hole, and a connecting part connected with the driving device. During washing/rinsing, the sealing part of the drain-sealing device keeps the drainage hole closed. During draining/dehydrating, the drain-sealing device opens the drainage hole under the action of the driving device. The drain-sealing device and the driving device are installed on the inner barrel, and rotate with the the inner barrel during dehydrating.

### TECHNICAL FIELD

This present disclosure relates to the technical filed of a laundry equipment, specifically, relates to water-free washing machine between inner and outer barrels.

### BACKGROUND

The existing washing machine comprises a housing, an outer barrel and an inner barrel which are arranged inside the housing. The inner barrel is rotatable arranged inside the outer barrel. In order to realize the clothes dehydrating function, a barrel wall of the inner barrel is provided with dehydrating holes. In this way, the washing water flows into the area between inner barrel and the outer barrel through the dehydrating holes during washing. This part of washing water cannot be fully utilized, and it results in the waste of water resource.

In addition, the problem that the water remains between the inner barrel and the outer barrel, will lead to dirt breeding on the outer wall of the inner barrel, the inner wall of the outer barrel and the area between the inner barrel and the outer wall. The user's clothes are polluted, and the user's laundry experience is seriously affected.

In order to solve the question mentioned above, a washing machine is provided; the main structural feature is that there is no hole in the barrel wall of the inner barrel. In this way, when washing clothes, water is only existed in the inner barrel while there is no water between inner barrel and outer barrel. It not only saves the water consumption for washing clothes, but also prevents the dirt from breeding between the inner barrel and the outer barrel. The clothes pollution is avoided, the washing effect is improved, and the user experience is enhanced.

After using the above free-water washing machine between the inner barrel and the outer barrel during washing for a period of time, the debris like silt after washing may not be discharged in time, since there is no hole on the inner barrel, which affects the user's washing effect.

In order to solve draining problem of the debris like sediment for the free-water washing machine between the inner barrel and the outer barrel during washing, the present disclosure is proposed.

### SUMMARY

In order to solve problems mentioned above, the present disclosure provides a free-water washing machine between inner and outer barrels. In particular, technical solutions as follows are adopted.

A free-water washing machine between inner and outer barrels, comprises:

an outer barrel;

an inner barrel rotatable arranged in the outer barrel.

During the washing/rinsing, the inner barrel contains water, and there is no water between the inner barrel and the outer barrel.

A drainage hole is provided in the bottom of the inner barrel. A drain-sealing device and a driving device are arranged on a bottom of the inner barrel. The drain-sealing device comprises a sealing part cooperating with the drainage hole to control the opening/closing of the drainage hole, and a connecting part connected with the driving device.

During washing/rinsing, the sealing part of the drain-sealing device keeps the drainage hole closed. During draining/dehydrating, the drain-sealing device opens the drainage hole under the action of the driving device.

Further, the sealing part is a water sealing cover; the connecting part is a level structure. A resistance arm of the level structure is connected with the water sealing cover, and a power arm is connected with the driving device.

The level structure, under the action of the driving device, drives the water sealing cover to close the drainage hole during the washing and rinsing, and to open the drainage hole during draining/dehydrating.

Further, the level structure comprises a level and a level bracket. The level bracket is fixed on an outer side of a bottom wall of the inner barrel. The level is rotatable arranged on the level bracket.

The driving device is a motor, an output end of the motor acts on the power arm of the level to drive the power arm of the level to move upward and downward, to drive the water sealing cover close the drainage hole during the washing and rinsing and to open the drainage hole during draining.

Further, an angle is formed between a power arm and a resistance arm of the level. The motor is a push-pull motor, and an output shaft of the push-pull shaft is connected with the resistance arm of the level.

Preferably, the angle between the power arm and the resistance arm of the level is larger than or equal to 90°.

Further, an elastic device is arranged on the level, and acts on the resistance arm of the level to drive the water sealing cover to reset and close the drainage hole.

Further, the driving device adopts a wireless charging module to perform power supply; or, the driving device comprises a battery module independently arranged to perform power supply.

Further, the wireless charging module comprises a power transmitting coil and a power receiving coil.

The power receiving coil is arranged on an outer wall of the bottom of the inner barrel and electrically connected to the driving device.

The power transmitting coil is arranged on an outer wall of the outer barrel or inside a housing of the washing machine and connected to a power source.

Further, the power transmitting coil is arranged on an outer side of a bottom of the outer barrel and corresponds to the power receiving coil.

Further, the driving device is hermetically arranged on the outer wall of the bottom of the inner barrel.

Further, an enclosed fitting is also comprised. The enclosed fitting is arranged on the outer wall of the bottom of the inner barrel. The drain-sealing device and driving device are both arranged in the enclosed fitting.

During the washing/rinsing process, the washing machine with no water between the inner and outer barrels provided by the present embodiment, the inner barrel contains water, and there is no water between the inner barrel and the outer barrel. That is, the inner barrel of the washing machine of the present disclosure is a water-tight inner barrel of which the barrel wall has no holes and the inside contains water for washing clothes. The drainage hole is arranged on the bottom of the inner barrel for draining after the washing.

The drain-sealing device and the driving device of the present disclosure are both installed on the inner barrel and rotate together with the rotation of the whole inner barrel during dehydrating. In this way, additional locking mechanism is no more needed to lock the inner barrel during the washing process. Thereby this problem is solved.

The free-water washing machine between the inner and outer barrels of the present disclosure realizes the draining of the water-tight inner barrel without holes on the barrel wall, and better solves the problem of accumulation of debris such as silt. It is simple in structure, and east to implement.

The driving device of the present disclosure is arranged on the rotatable inner barrel of the washing machine, and power cannot be supplied through the normal wire. The present disclosure adopts the mode of wireless charging to realize the power supply.

During the washing process, the power transmitting coil is not energized. According to the principle of electromagnetic induction, the power receiving coil won't generate current, and cannot supply power to the driving device. The water sealing cover is installed on the level, and blocks the drainage hole on the bottom of the inner barrel under the action of the elastic device installed on the level bracket, realizing no leakage during the washing process.

During draining water, the power transmitting coil is energized. According to the principle of the electromagnetic induction, the power receiving coil generates induced current and supplies power to the driving device. The driving device operates and pulls the level. According to the level principle, the water sealing cover will open the drainage hole on the bottom of the inner barrel, realizing water drainage.

During dehydration, the power transmitting coil keeps energized. According to the principle of the electromagnetic induction, the power receiving coil generates induced current, and continuously supplies power to the driving device. The driving device operates and pulls the level. According to the level principle, the water sealing cover keeps opening the drainage hole on the bottom of the inner barrel. A part of water thrown out and debris such as silts generated from the washing process can be discharged from the drainage hole. During the dehydration process, the drain-sealing device, the driving device and the power receiving coil all rotate together with the inner barrel, avoiding the driving device being arranged on the outer barrel, avoiding the location problem caused by the driving device being arranged on the outer barrel.

### BRIEF DESCRIPTION OF THE DRAWINGS

FIG. 1 is a stereoscopic structure diagram of a free-water washing machine between inner and outer barrels of the present disclosure;

FIG. 2 is a sectional view of the free-water washing machine between the inner and outer barrels of the present disclosure;

FIG. 3 is a principle diagram I of power supply for the driving device of the free-water washing machine between the inner and outer barrels of the present disclosure;

FIG. 4 is a principle diagram II of power supply for the driving device of the free-water washing machine between the inner and outer barrels of the present disclosure;

Reference signs: 1—flange plate 2—speed reducer 3—water sealing cover 4—level 5—spring 6—level bracket 7—motor 8—power receiving coil 9—inner barrel bottom 10—inner barrel 11—outer barrel 12—power transmitting coil 13—drainage hole 14—power transmitting coil capacitor 15—power source 16—power receiving coil capacitor 17—water retaining rib 18—slit.

### DETAILED DESCRIPTION

A free-water washing machine between inner and outer barrels of the present disclosure is described in detail below with reference to the drawings.

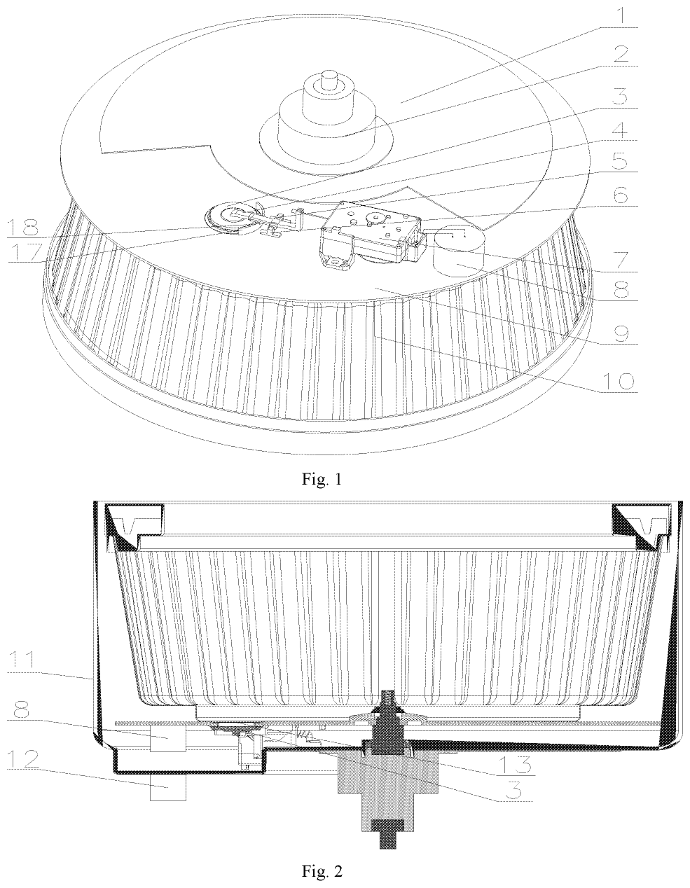

As shown in FIGS. 1 and 2, the free-water washing machine between inner and outer barrels of the present embodiment comprises:

an outer barrel 11,

an inner barrel 10, rotatably arranged in the outer barrel 11.

During the washing/rising process, the inner barrel 10 contains water, and there is no water between the inner barrel 10 and the outer barrel 11.

A drainage hole 13 is arranged on the bottom of the inner barrel 10, and a drain-sealing device and a driving device are arranged on the bottom of the inner barrel 10. The drain-sealing device comprises a sealing part cooperating with the drainage hole to control the opening/closing of the drainage hole, and a connecting part connected with the driving device.

During washing/rinsing, the sealing part of the drain-sealing device keep the drainage hole closed, during dehydrating, the drainage hole is opened by the drain-sealing device under the action of the driving device.

The drainage hole 13 is sealed by the drain-sealing device provided by the present embodiment during the washing/rinsing process, avoiding the washing water entering into the area between the inner barrel 10 and the outer barrel 10, keeping the area between the barrels free of water, avoiding breeding dirt and polluting users' clothes. The drainage hole 13 is opened by the drain-sealing device during dehydrating, not only realizing dehydrating and draining, but also draining the debris such as silt from the washing process and keeping the cleanness in the inner barrel.

The driving device provided by the present embodiment comprises a power source that drives the drain-sealing device to open/close the drainage hole 13.

The inner barrel 10 provided by the present embodiment comprises an inner barrel bottom 9, and the drainage hole 13 is arranged on the inner barrel bottom 9.

During the washing/rinsing process of the free-water washing machine between the inner and outer barrels provided by the present embodiment, the inner barrel 10 contains water, and there is no water between the inner barrel 10 and the outer barrel 11. That is, the inner barrel 10 of the washing machine of the present disclosure is a water-tight inner barrel of which the barrel wall has no holes and the inside contains water for washing clothes. The drainage hole 13 is arranged on the bottom of the inner barrel 10 for draining after the washing.

In the present embodiment, the drain-sealing device and the driving device are both installed on the inner barrel, and rotate together with the rotation of the whole inner barrel during dehydrating. In this way, additional locking mechanism is no more needed to lock the inner barrel during the washing process. Thereby, it realizes the draining of the water-tight inner barrel without holes on the barrel wall, and better solves the problem of accumulation of debris such as silt. It is simple in structure, and east to implement.

In addition, as a preferred implementing mode of the present embodiment, only on the upper part of the side wall is the inner barrel 10 provided with a ring of dehydrating-drainage hole. The dehydrating-drainage hole is arranged beyond the largest intake volume of the inner barrel of the washing machine, for draining the water to-be-dehydrated during the dehydration. The other part of the side wall of the inner barrel 10 is designed to be closed, without any through-hole structure. At the same time, the bottom wall of the inner barrel 10 is provided with one drainage hole 13 with larger hole diameter which is closed during the washing and rinsing process and is opened during draining, while the other part of the bottom wall of the inner barrel is designed to be closed.

As a preferred implementing mode of the present embodiment, the drain-sealing device and the driving device are both arranged on the outer wall of the bottom of the inner barrel.

As an implementing mode of the present embodiment, the sealing part provided by the present embodiment comprises a water sealing cover 3, and the connecting part comprises a level structure. A resistance arm of the level structure is connected with the water sealing cover 3, and a power end is connected with the driving device. The level structure, under the action of the driving device, drives the water sealing cover to close the drainage hole during the washing and rising process, and to open the drainage hole during draining water. The drain-sealing device provided by the present embodiment adopts the level structure, the opening or closing of the drainage hole is under the action of the level, which is more reliable.

Further, the level structure provided by the present embodiment comprises a level 4 and a level bracket 6. The level bracket 6 is fixed on the outer side of the bottom wall of the inner barrel 10, and the level 4 is rotatably arranged on the level bracket 6. In the present embodiment, in order to realize the level movement of the level structure, the output end of the driving device should act on the power end of the level, specifically:

Implementing mode I: the driving device provided by the present implementing mode comprises a cam and a motor. The cam is installed on an output shaft of the motor, and rotates under the driving of the motor. The cam is arranged on the outer side of the bottom wall of the inner barrel 10. The contour curved surface of the cam is in contact with the power arm of the level 4. The contour curved surface, along with the rotation of the cam, presses/releases the power arm of the level 4 to realize the level movement of the level structure.

In the present embodiment, during the rotation process of the cam, the different curved surface of the contour curved surface is in contact with the power arm of the level 4. When the surface of large radius of curvature is in contact with the power arm of the level 4, the power arm of the level 4 is pressed by the cam. The power arm of the level 4 moves upward under the pressure, while the resistance arm of the level 4 moves downward to drive the water sealing cover 3 to open the drainage hole 13. When the surface of small radius of curvature is in contact with the power arm of the level 4, the power arm of the level 4 is released by the cam. The power arm of the level 4 is returned downward, the resistance arm of the level 4 moves upward to drive the water sealing cover 3 to close the drainage hole.

The contour curved surface of the present disclosure at least comprises a first curved surface, a second curved surface and a third curved surface. The radius of curvature of the first curved surface gradually increases. The radius of curvature of the second curved surface is equal to the maximum value of the radius of curvature of the first curved surface. The radius of curvature of the third curved surface is slightly smaller than that of the second curved surface. Therefore, when the water sealing cover 3 of the present disclosure is closed, the first curved surface of the contour curved surface is in contact with the power arm of the level 4. During the rotation of the contour curved surface along with the cam, the power arm of the level 4 is separately in contact with the first curved surface and the second curved surface. When reaching the second curved surface of largest radius of curvature, it continues to rotate until reaching the third curved surface and then stops. The power arm of the level 4 is pressed downward by the third curved surface, and the water sealing cover 3 is opened. In this way, when the cam stops rotation, it can preventing the cam form rotating back since the radius of curvature of the third curved surface is slightly smaller than that of the second curved surface, making sure that the opening condition of the water sealing cover 3 is more reliable.

Implementing mode II: the driving device provided by the present implementing mode is the motor 7. The output end of the motor 7 acts on the power arm of the level to drive the power arm of the level to move upward and downward. The water sealing cover 3 is driven to close the drainage hole during the washing and rising process, and to open the drainage hole during draining water.

Further, an angle is arranged between the power arm and the resistance arm of the level 4. The motor 7 is a push-pull motor, and an output shaft of the push-pull motor is connected with the resistance arm of the level. In the present embodiment, the power arm of the level 4 can be pulled to move upward and downward by the telescopic movement of the push-pull motor, thereby realizing the level movement of the level structure to close/open the drainage hole 13.

Preferably, the angle between the power arm and the resistance arm of the level is larger than or equal to 90°. The arrangement of the obtuse angle between the power arm and the resistance arm of the level can make sure that the power output from the push-pull motor is more decomposed into the force along the vertical direction to realize the level movement.

As a preferred implementing mode of the present embodiment, an elastic device is arranged on the level, and acts on the resistance arm of the level 4 to drive the water sealing cover to reset and close the drainage hole 13.

Specifically, a spring 5 for resetting of the level 4 is arranged between the level 4 and the level bracket 6 of the level structure. In the present embodiment, the spring 5 can realize the reset of the level 4 and keep the drainage hole 13 closed. It is simple in structure, easy in installation, reliable and effective.

As a preferred implementing mode of the present embodiment, the water sealing cover 3 is connected by the resistance arm of the level structure by a hinge. The sealing-water cover 3 is freely rotatable around the centre line of the resistance arm of the level structure. A movable angle in a range of 0˜15° is provided between the water sealing cover 3 and the bottom wall of the inner barrel, preferably, the movable angle is 5°. Since the movement track of the level structure is a straight line, when the water sealing cover 3 is covered on the drainage hole, there may be a part that contacts first and the other part that does not contact, which may lead the drainage hole not to be fully covered and to leak. The water sealing cover 3 is connected to the level structure by the hinged mode. In this way, it allows the water sealing cover 3 to be provided with a certain of movable angle, which is more convenient for the water sealing cover 3 to cover the drainage hole.

As a preferred implementing mode of the present embodiment, a water retaining rib 17 is arranged on the periphery of the drainage hole of the inner barrel 10. The water retaining rib 17 is mainly used for preventing water flow from flushing the level structure during the draining water from the drainage hole 13, thereby preventing the level structure form being unstable and being damaged. Further, the water retaining rib is provided with a slit 18 at the corresponding level 4, thereby preventing the water retaining rib 17 from hindering the normal rise and fall of the level 4 and making the closing and opening of the water sealing cover 3 more successful. Since the water retaining rib is only used for reducing the water flow flowing to the level structure, the water retaining rib 17 is preferably arranged on one side of the drainage hole close to the level structure.

The driving device of the present disclosure is arranged on the rotatable inner barrel of the washing machine, and power cannot be supplied through the normal wire. The present disclosure adopts the mode of wireless charging to realize the power supply.

The principle of the wireless charging:

It is well known that when current flows through a coil, a magnetic field is generated in the surroundings. And other unenergized coils approach the magnetic field, current is generated in the coil, thereby supplying power to the driving device.

Therefore, by arranging the coils that can resonate with the magnetic field, it can extend the power supply distance on the basis of realizing the wireless power supply.

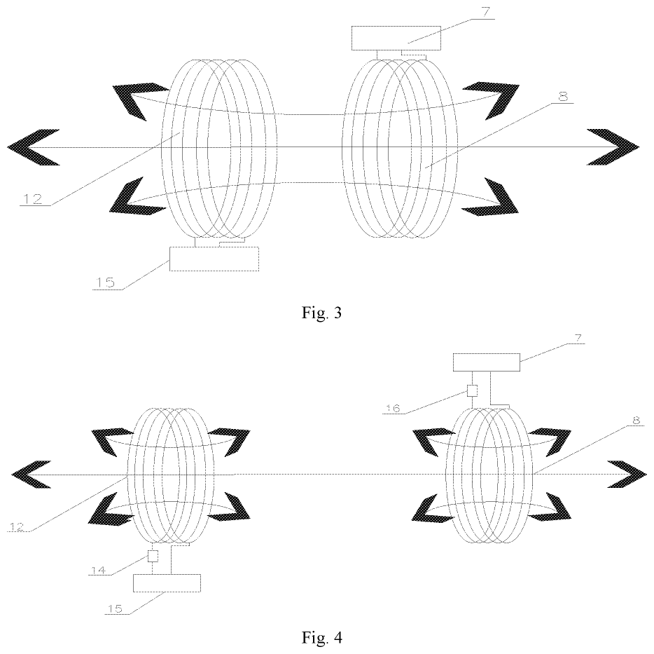

As shown in FIGS. 2, 3 and 4, the free-water washing machine between the inner and outer barrels is provided, the driving device adopts a wireless charging module to perform power supply.

Specifically, the wireless charging module comprises a power transmitting coil 12 and a power receiving coil 8. The power receiving coil 8 is arranged on the outer wall of the bottom of the inner barrel 10 and electrically connected to the driving device. The power transmitting coil 12 is arranged on the outer wall of the outer barrel or inside the housing of the washing machine and connected to the power source 15.

Preferably, the power transmitting coil 12 is arranged on the outer side of the bottom of the outer barrel and corresponds to the power receiving coil 8, thereby improving the transmission power of the wireless charging.

Further, a power transmitting coil capacitor 14 is connected in series between the power transmitting coil 12 and the power source provided by the present embodiment. A power receiving coil capacitor 16 is connected in series between the power receiving coil 8 and the driving device. Thereby the adaptability and stability of the entire wireless charging system is enhanced.

During the washing process, the power transmitting coil 12 is not energized. According to the principle of electromagnetic induction, the power receiving coil 8 won't generate current, and cannot supply power to the driving device. The water sealing cover 3 is installed on the level 4 and blocks the drainage hole 13 on the bottom of the inner barrel 10 under the action of the elastic device installed on the level bracket 6, realizing no leakage during the washing process.

During draining water, the power transmitting coil 12 is energized. According to the principle of the electromagnetic induction, the power receiving coil 8 generates induced current and supplies power to the driving device. The driving device operates and pulls the level 4. According to the level principle, the water sealing cover 3 will open the drainage hole 13 on the bottom of the inner barrel 10, realizing water drainage.

During dehydration, the power transmitting coil 12 keeps energized. According to the principle of the electromagnetic induction, the power receiving coil 8 generates induced current, and continuously supplies power to the driving device. The driving device operates and pulls the level 4. According to the level principle, the water sealing cover 3 keeps opening the drainage hole 13 on the bottom of the inner barrel 19. A part of water thrown out and debris such as silts generated from the washing process can be discharged from the drainage hole 13. During the dehydration process, the drain-sealing device, the driving device and the power receiving coil all rotate together with the inner barrel, avoiding the driving device being arranged on the outer barrel, avoiding the location problem caused by the driving device being arranged on the outer barrel.

As an implementing mode of the present embodiment, the driving device comprises a battery module independently arranged for supplying power. The battery module provided by the present embodiment is hermetically installed, and is detachably taken out for charging, or directly charged by wire-connection.

As an implementing mode of the present embodiment, the driving device is hermetically installed on the outer side of the bottom of the inner barrel.

Specifically, the washing machine provided by the present embodiment further comprises an enclosed fitting. The enclosed fitting is hermetically installed on the outer side of the bottom of the inner barrel. The drain-sealing device and the driving device are both arranged inside the enclosed fitting.

The foregoing is merely illustrative of the preferred embodiments of the present disclosure and is not intended to be limiting of the present disclosure. While the disclosure has been disclosed by way of example with reference to the preferred embodiments, it is not intended to be limiting of the disclosure. Any person skilled in the art will, without departing from the scope of the technical solution of the present disclosure, may make use of the technical contents of the above-mentioned tips to make some alterations or modifications to equivalent embodiments, but without departing from the scope of the technical solution of the present disclosure. Any and all modifications, equivalents, and modifications of the foregoing embodiments are within the scope of the present disclosure without departing from the spirit of the technical solution of the present disclosure in accordance with the technical details of the present disclosure.

1. A washing machine, comprising:
an outer barrel;
an inner barrel, being rotatably arranged in the outer barrel; wherein
during a washing process or a rinsing process, the inner barrel contains water, and there is no water between the inner barrel and the outer barrel; and
a drainage hole is arranged on a bottom of the inner barrel, a drain-sealing device and a driving device are arranged on the bottom of the inner barrel, the drain-sealing device comprises a sealing part cooperating with the drainage hole to control opening/closing of the drainage hole and a connecting part connected with the driving device;
the sealing part of the drain-sealing device keeps the drainage hole closed during the washing process or the rinsing process, and the drain-sealing device opens the drainage hole under an action of the driving device during a draining or a dehydrating.

2. The washing machine according to claim 1, wherein, the sealing part is a water sealing cover, the connecting part comprises a level structure; a resistance arm of the level structure is connected with the water sealing cover, and a power arm of the level structure is connected with the driving device;
the level structure, under the action of the driving device, drives the water sealing cover to close the drainage hole during the washing process or rinsing process, and to open the drainage hole during the draining or the dehydrating.

3. The washing machine according to claim 2, wherein, the level structure comprises a level and a level bracket, the level bracket is fixed on an outer side of the bottom of the inner barrel, the level is rotatably arranged on the level bracket;
the driving device is a motor, an output end of the motor acts on the power arm of the level to drive the power arm of the level to move upward and downward, so that the water sealing cover is driven to close the drainage hole during the washing process and rinsing process, and to open the drainage hole during the draining.

4. The washing machine according to claim 3, wherein, an angle is arranged between the power arm and the resistance arm of the level, the motor is a push-pull motor, and an output shaft of the push-pull shaft is connected with the resistance arm of the level.

5. The washing machine according to claim 3, wherein, an elastic device is arranged on the level, and acts on the resistance arm of the level to drive the water sealing cover to reset and close the drainage hole.

6. The washing machine according to claim 1, wherein, the driving device uses a wireless charging module for power supply; or, the driving device comprises an independent battery module for power supply.

7. The washing machine according to claim 6, wherein, the wireless charging module comprises a power transmitting coil and a power receiving coil;
the power receiving coil is arranged on an outer side of the bottom of the inner barrel and is electrically connected to the driving device;
the power transmitting coil is arranged on an outer wall of the outer barrel or inside a housing of the washing machine and connected to a power source.

8. The washing machine according to claim 7, wherein, the power transmitting coil is arranged on an outer side of a bottom of the outer barrel, and corresponds to the power receiving coil.

9. The washing machine according to claim 1, wherein, the driving device is hermetically arranged on the outer wall of the bottom of the inner barrel.

10. The washing machine according to claim 9, comprises an enclosed fitting arranged on the outer wall of the bottom of the inner barrel, the drain-sealing device and driving device are both arranged in the enclosed fitting.

11. The washing machine according to claim 4, wherein the angle between the power arm and the resistance arm of the level is larger than or equal to 90°.

12. The washing machine according to claim 3, wherein, the driving device uses a wireless charging module for power supply; or, the driving device comprises an independent battery module for power supply.

13. The washing machine according to claim 5, wherein, the driving device uses a wireless charging module for power supply; or, the driving device comprises an independent battery module for power supply.

14. The washing machine according to claim 3, wherein, the driving device is hermetically arranged on the outer wall of the bottom of the inner barrel.

15. The washing machine according to claim 5, wherein, the driving device is hermetically arranged on the outer wall of the bottom of the inner barrel.
